(19) United States
(12) Patent Application Publication
(10) Pub. No.: US 2023/0421647 A1
(43) Pub. Date: Dec. 28, 2023

(54) METHOD FOR COMMUNICATING BETWEEN SWEEPING ROBOT AND BASE STATION, ELECTRONIC DEVICE AND STORAGE MEDIUM

(71) Applicant: Guangyu HUA, Shenzhen City (CN)

(72) Inventor: Guangyu HUA, Shenzhen City (CN)

(21) Appl. No.: 17/876,459

(22) Filed: Jul. 28, 2022

(30) Foreign Application Priority Data
Jun. 27, 2022 (CN) 202210734199.5

(51) Int. Cl. H04L 67/51

(52) U.S. Cl. CPC H04L 67/51

(57) ABSTRACT

The present application relates to a method for communicating between a sweeping robot and a base station, an electronic device, and a computer-readable storage medium. The method for communicating between a sweeping robot and a base station includes: receiving and responding to, through a service party, a service request of a requesting party to send a service information to the requesting party, such that the requesting party selects a target service information in the service information after receiving the service information; and receiving, through the service party, the target service information sent by the requesting party, constructing a binary tree according to the target service information, and executing the target service based on the binary tree; the service party is the sweeping robot or the base station, and the requesting party is the base station or the sweeping robot corresponding to the service party.

### CROSS REFERENCE TO RELATED APPLICATION

The present application claims priority to the following Chinese Patent Application, with Application No. 202210734199.5, filed on Jun. 27, 2022; the entire content of which is incorporated herein by reference.

### TECHNICAL FIELD

The present application relates to the technical field of sweeping robots, and more particularly to a method and a system for communicating between a sweeping robot and a base station, an electronic device, and a computer-readable storage medium.

### BACKGROUND

The sweeping robot is a smart home device that can clean the ground autonomously, and the sweeping robot has been widely used in home life. The sweeping robot is equipped with a corresponding charging base station, which can realize various functions such as charging, cleaning, and adding water to the water tank, etc. However, the current charging base station and the sweeping robot can only carry out simple instruction transmission, which cannot meet the complex information interaction.

When controlling the sweeping robot, the user terminal generally controls the sweeping robot directly and remotely through the cloud service party, and a large amount of data needs to be transferred and processed in the cloud server, and there is a serious risk of privacy data leakage.

### SUMMARY

A method and a system for communicating between a sweeping robot and a base station, a device, and an apparatus are provided to solve technical problem that the communication manner between the sweeping robot and the base station in the art cannot meet the requirements of complex and intelligent information interaction.

According to a first aspect, an embodiment of the present application provides a method for communicating between a sweeping robot and a base station, which includes:
receiving and responding to, through a service party, a service request of a requesting party to send a service information to the requesting party, such that the requesting party selects a target service information in the service information after receiving the service information; and
receiving, through the service party, the target service information sent by the requesting party, constructing a binary tree according to the target service information, and executing the target service based on the binary tree;
the service party is the sweeping robot or the base station, and the requesting party is the base station or the sweeping robot corresponding to the service party.

By receiving and responding to, through the service party, the service request of the requesting party, and constructing a binary tree according to the target service according to the target service information selected by the requesting party to execute the target service, a private communication manner is established between the sweeping robot and the base station, and the requirement of the complex information interaction between the sweeping robot and the base station is satisfied; in addition, the sweeping robot and the base station construct a complete communication system through the private communication manner, the data obtained by the robot or the base station is processed in the communication system, and the base station and the sweeping robot can realize all mutual control functions, and the important privacy data leakage can be effectively prevented.

In combination with the first aspect, in a first implementation of the first aspect, the target service information includes a target service name and a target service parameter, and constructing the binary tree according to the target service information includes:
obtaining a target service instruction corresponding to the target service name and the target service parameter; and
storing the target service instruction as a binary tree structure.

The service information is a service information including all the services of the sweeping robot and the base station, and the target service instruction is configured for the mutual control and information interaction between the sweeping robot and the base station. According to the target service name and the target service parameter, the target service instruction can be quickly obtained, and then the binary tree of the target service can be quickly generated according to the obtained target service instruction, which greatly shortens the communication establishment time between the sweeping robot and the base station and the execution time of the target service.

In combination with the first aspect, in a second implementation of the first aspect, executing the target service based on the binary tree includes:
sending an execution result of a current sub-tree of the binary tree to the requesting party, such that after the requesting party receives the execution result, determining a next execution sub-tree of the binary tree according to the execution result.

The service party executes the target service according to the binary tree, communicates with the requesting party from a root node of the binary tree, and sends the execution result of the current sub-tree to the requesting party. The requesting party determines the next execution sub-tree after receiving the execution result, and the service party determines which sub-tree to enter according to the feedback from the requesting party, so as to complete the execution of the target service. The data interaction between the service party and the requesting party is completed by using the binary tree, which overcomes the defect of simple instruction control between the traditional sweeping robot and the base station, and the complex interaction process between the sweeping robot and the base station can be realized.

In combination with the first aspect, in a third implementation of the first aspect, receiving and responding to, through the service party, the service request of the requesting party includes:
receiving and responding to, through the service party, a service request initiated by a remote device transmitted by the requesting party; and
executing the target service based on the binary tree includes:
sending an execution result of a current sub-tree of the binary tree to the requesting party, such that the requesting party transmits the execution result to the remote device, and determining, through the remote device, a next execution sub-tree of the binary tree according to the execution result.

When the remote device requests for a service, the requesting party transmits the service request initiated by the remote device to the service party; when the service party responds to the service request of the remote device and executes the target service, the execution result of the target service is transmitted to the remote device through the requesting party, so as to realize the remote interactive communication between the remote device and the service party. In the present application, the data between the service party and the remote device needs to be processed by the requesting party, and the service party does not directly interact and communicate with the remote device, which avoids the problem of privacy data leakage that needs to be transferred to the external network when the service party is in information interaction with the remote device.

In combination with the first aspect, in a fourth implementation of the first aspect, receiving and responding to, through the service party, the service request of the requesting party includes:
receiving, through the service party, one or more service requests sent by one or more requesting parties, and responding to a service request with a highest priority.

Each service of the sweeping robot and the base station has a priority, and the corresponding service request has a priority. When the service party receives a plurality of service requests at the same time, the service party responds to the service request with the highest priority and preferentially executes the target service with the highest priority. The priority of the service is set according to the actual situation, the more important service is preferentially executed, and the home life experience brought by the sweeping robot and the base station can be improved.

In combination with the first aspect, in a fifth implementation of the first aspect, after executing the target service based on the binary tree, further includes:
determining whether a priority of a new target service is higher than a priority of a target service currently executed when an execution condition of the new target service is generated; and
if so, suspending the target service currently executed through the service party, and preferentially executing the new target service.

Each service of the sweeping robot and the base station has a priority. When the service party executes the current target service, the execution condition of the new target service is generated, it is necessary to determine whether the priority of the new target service is higher than that of the current target service; if not, continuing to execute the current target service; if so, suspending the execution of the current target service, the requesting party of the new target service sends a new service request to the service party of the new target service according to the execution condition of the new target service, to preferentially execute new target service. The priority of service can be set according to the actual situation, and the more important service is preferentially executed to ensure the smooth work of the sweeping robot and the base station.

In combination with the fifth implementation of the first aspect, in a sixth implementation of the first aspect, after preferentially executing the new target service, further comprises:
reconstructing a binary tree according to the target service information, and recovering to execute the target service based on the binary tree reconstructed.

After the service party of the new target service preferentially executes the new target service, the service party of the current target service reconstructs the binary tree, and the execution of the current target service is recovered according to the binary tree. It is ensured that after the current target service is interrupted by a new target service with a higher priority during the execution process, the current target service can be automatically recovered and the current target service can be successfully completed.

According to a second aspect, an embodiment of the present application provides an electronic device, which includes a memory, a processor, and a computer program stored in the memory and running on the processor; when the computer program is executed by the processor, the steps of the any one of method in the first aspect are implemented.

According to a third aspect, an embodiment of the present application provides a computer-readable storage medium storing a computer program, when the computer program is executed by a processor, the steps of the any one of method in the first aspect are implemented.

The beneficial effects that the embodiments of the present application have compared with the prior art are that by receiving and responding to, through the service party, the service request of the requesting party, and constructing a binary tree according to the target service according to the target service information selected by the requesting party to execute the target service, a private communication manner is established between the sweeping robot and the base station, and the requirement of the complex information interaction between the sweeping robot and the base station is satisfied; in addition, the sweeping robot and the base station construct a complete communication system through the private communication manner, the data obtained by the robot or the base station is processed in the communication system, the base station and the sweeping robot can not only realize all mutual control functions, but also the data between the service party and the remote device needs to be processed by the requesting party, the service party does not directly communicate with the remote device, which avoids the problem of privacy data leakage when the service party is in information interaction with the remote device and needs to transfer data in the external network.

### BRIEF DESCRIPTION OF THE DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a schematic flowchart of an implementation of a method for communicating between a sweeping robot and a base station provided by an embodiment of the present application;

FIG. 2 is a schematic diagram of a binary tree of a sweeping service performed by a sweeping robot provided by an embodiment of the present application;

FIG. 3 is a schematic flowchart of establishing an initial connection between a base station and a sweeping robot provided by an embodiment of the present application;

FIG. 4 is a schematic flowchart of establishing a socket connection between a base station and a sweeping robot provided by an embodiment of the present application;

FIG. 5 is a schematic diagram of a base station and a sweeping robot using a heartbeat packet to maintain a socket connection according to an embodiment of the present application;

FIG. 6 is a schematic diagram of a system for communicating between a sweeping robot and a base station provided by an embodiment of the present application; and

FIG. 7 is a schematic diagram of an electronic device provided by an embodiment of the present application.

### DETAILED DESCRIPTION OF EMBODIMENTS

In the following description, for the purpose of illustration rather than limitation, specific details such as a specific system structure and technology are set forth in order to provide a thorough understanding of the embodiments of the present application. However, it will be apparent to those skilled in the art that the present application may be practiced in other embodiments without these specific details. In other instances, detailed descriptions of well-known systems, devices, circuits, and methods are omitted so as not to obscure the description of the present application with unnecessary detail.

In order to illustrate the technical solutions described in the present application, the following specific embodiments are used for description.

The sweeping robot mentioned in the embodiments of the present application refers to an automated device used for environmental cleaning, including but not limited to sweeping robots, mopping robots, etc.; the base station refers to the charging base station used in conjunction with the sweeping robot, which can charge the sweeping robot, or suck out the dust in the dust box of the sweeping robot, or clean the mop of the sweeping robot, or add water to the water tank of the sweeping robot, etc.

At present, between the current sweeping robot and the base station, the wireless serial communication protocol is generally used to realize simple instruction transmission, and complex and smooth information interaction cannot be carried out. With the continuous development of science and technology, the current communication method can no longer meet the interaction needs of highly intelligent sweeping robot and the base station in the future.

In addition, at present, the mobile terminal APP is generally used to remotely control the sweeping robot, and the data transmission between the mobile terminal APP and the sweeping robot needs to be transferred in the cloud. With the application and development of the computer vision technology of the sweeping robot, the method for data transferring will lead to the leakage of important private data.

Based on the problems existing in the prior art, the embodiments of the present application provide a method for communicating between a sweeping robot and a base station. By establishing a private communication manner dedicated to the sweeping robot and the base station, the requirement of the complex information interaction between the sweeping robot and the base station is satisfied; in addition, the sweeping robot and the base station construct a complete communication system through the private communication manner, the data obtained by the robot or the base station is processed in the communication system, the base station and the sweeping robot can not only realize all mutual control functions, and when the remote device requests a service, the data between the service party and the remote device needs to be processed by the requesting party, which avoids the problem of privacy data leakage when the service party is in information interaction with the remote device and needs to transfer data in the external network.

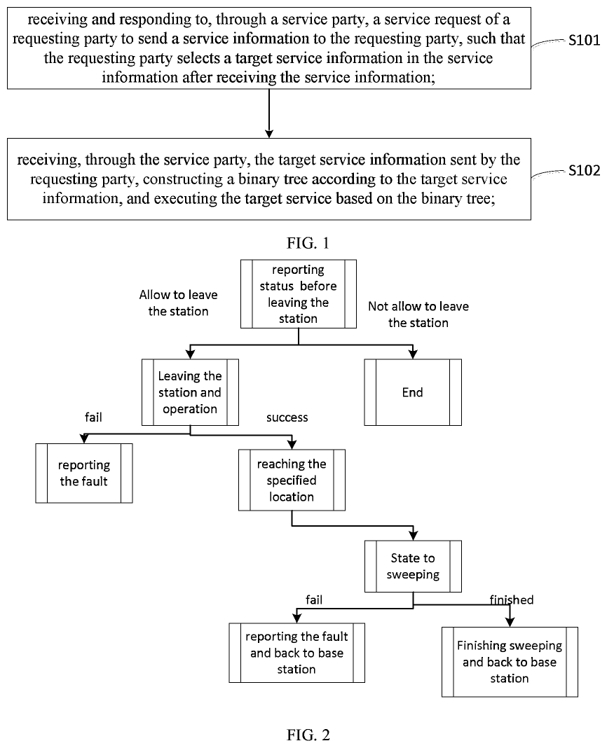

As shown in FIG. 1, an embodiment of the present application provides a method for communicating between a sweeping robot and a base station, and the method includes the following steps:

S101, receiving and responding to, through a service party, a service request of a requesting party to send a service information to the requesting party, such that the requesting party selects a target service information in the service information after receiving the service information;

S102, receiving, through the service party, the target service information sent by the requesting party, constructing a binary tree according to the target service information, and executing the target service based on the binary tree;

The service party is the sweeping robot or the base station, and the requesting party is the base station or the sweeping robot corresponding to the service party.

It can be understood that the service refers to the functions of the sweeping robot and the base station, such as charging function, sweeping function, etc., one service corresponds to one function, and all the services of the sweeping robot and the base station in the embodiment of the present application form a service set, and are stored in the sweeping robot or the base station in the form of firmware. The target service refers to the function that the sweeping robot or base station needs to perform according to the service request.

Service information includes all service information of the sweeping robot and base station, including but not limited to the service name, the service parameter, etc. The service name is used to indicate the service, and the service parameter is used to indicate the execution of the service. For example, in the sweeping service, the location parameter is used to indicate that the position where the sweeping robot needs to go to and for sweeping. The embodiment of the present application specifically displays and transmits the service information in the form of a list. The target service information includes but is not limited to the target service name and target service parameter(s), and the service party can quickly obtain the target service according to the content of the target service information.

The requesting party refers to a party that sends the service request, and the service party refers to a party that receives the service request and executes the service. Both the sweeping robot and the base station can request the service from the other party, and can establish a communication connection to interact with the other party after receiving the requested service.

The method for communicating between the sweeping robot and the base station in the embodiment of the present application can be applied in various interaction scenarios, such as the interaction scene between the local devices (the sweeping robot and the base station), the interaction between the local devices (the sweeping robot and the base station) and the remote device scene and so on. Herein, the embodiments of the present application provide specific descriptions of two interaction scenarios, that is, an interaction scenario between local devices (sweeping robots or base stations), and an interaction scenario between the sweeping robot and a remote device.

First, in the interaction scenario between local devices (sweeping robots or base stations), one of the sweeping robot and the base station requests a service from the other party, and one of the sweeping robot and the base station is the requesting party, and another party corresponding to the sweeping robot or the base station is the service party, and the steps for establishing the method for communicating are:

A101, receiving and responding to, through a service party, a service request of a requesting party to send a service information to the requesting party, such that the requesting party selects a target service information in the service information after receiving the service information;

In step A101, the requesting party sends a service request to the service party; after the service party receives and responds to the service request, the service party sends service information to the requesting party, where the service information is a list including the service name and the service parameter(s); after the requesting party receives the service information, selecting the target service information corresponding to the target service from the list of the service information, that is, the target service name and target service parameter, and then assembling the target service name and target service parameter into a data package and sending the data package to the service party according to the requirements of the list.

A102, receiving, through the service party, the target service information sent by the requesting party, constructing a binary tree according to the target service information, and executing the target service based on the binary tree.

In an embodiment, the target service information includes a target service name and a target service parameter, and constructing the binary tree according to the target service information includes: obtaining a target service instruction corresponding to the target service name and the target service parameter; and storing the target service instruction as a binary tree structure.

In an embodiment, executing the target service based on the binary tree includes: sending an execution result of a current sub-tree of the binary tree to the requesting party, such that after the requesting party receives the execution result, determining a next execution sub-tree of the binary tree according to the execution result.

In step A102, after receiving the data packet including the target service name and the target service parameter sent by the requesting party, obtaining the corresponding target service instruction according to the target service name and the target service parameter, and the target service instruction is the instruction set of the target service; then storing the obtained target service instruction as a binary tree structure, the binary tree is an ordered tree with at most two sub-trees per node, and nodes can be increased or reduced according to the requirements of the service party or requesting party; and finally, executing the target service based on the binary tree through the service party, during the execution process, the execution process is started from the root node of the binary tree firstly, starting to communicate with the requesting party, executing the sub-tree of the binary tree; and then sending the execution result of the current sub-tree to the requesting party; then determining, through the requesting party, the next execution sub-tree of the binary tree according to the execution result; then adjusting the binary tree, and determining, through the service party, which sub-tree to enter according to the data feedback by the requesting party; and when entering an empty sub-tree, the service party completes the target service process. As shown in FIG. 2, a schematic diagram of a binary tree of a sweeping service performed by a sweeping robot provided by an embodiment of the present application.

In other embodiments, in order to ensure that the sweeping robot and the base station work smoothly when sweeping, and to cope with various situations during communication interaction, the present application sets a different priority order for each service.

In an embodiment, in step A101, receiving and responding to, through the service party, the service request of the requesting party includes: receiving, through the service party, one or more service requests sent by one or more requesting parties, and responding to a service request with a highest priority.

In an embodiment, in step A102, after executing the target service based on the binary tree, further includes: determining whether a priority of a new target service is higher than a priority of a target service currently executed when an execution condition of the new target service is generated; and if so, suspending the target service currently executed through the service party, and preferentially executing the new target service. After preferentially executing the new target service, further includes: reconstructing a binary tree according to the target service information, and recovering to execute the target service based on the binary tree reconstructed.

The embodiment of the present application considers that the service party receives a plurality of service requests. If the service party receives one or more service requests sent by one or more requesting parties at the same time, it can be understood that the service party and the requesting party here are not a fixed party, but under different service requests, the service party and the requesting party can be the same device. For example, under the request of the sweeping service, the service party is the sweeping robot, and the requesting party is the base station; under the request of the charging service, the service party is the base station, and the requesting party is the sweeping robot. When the service party receives a plurality of service requests, according to the set service priority, the corresponding service request also has a priority, so the service party responds to the service request with the highest priority and executes the service with the highest priority.

The embodiment of the present application also considers that the service party may request other services during the execution of the current target service. If the service party generates the execution condition of the new target service when executing the current target service, it is necessary to determine whether the priority of the new target service is higher than that of the current target service; if not, the service party continues to execute the current target service; if so, the service party suspends the execution of the current target service, the requesting party of the new target service sends a new service request to the service party of the new target service according to the execution condition of the new target service, to preferentially execute new target service according to the service request. After the service party of the new target service has executed the new target service with a higher priority, the service party of the current target service reconstructs the binary tree, and recovering to execute the current target service according to the binary tree, so as to ensure that the previous target service can be successfully completed.

For the above method for communicating, for better understanding and explanation, the embodiment of the present application provides a specific example: the base station requests a sweeping service from the sweeping robot, and the sweeping robot is insufficient in power during the sweeping service.

Combining the above method, firstly, the base station (the requesting party) sends a sweeping service request to the sweeping robot (the service party); after receiving the service request, the sweeping robot sends service information to the base station; after the base station receives the service information, and in the service information, the base station selects the target service and the target service parameter, while the target service is a target service name for sweeping and the target service parameter is a specified location, and then the target service and the target service parameter are sent to the sweeping robot; the sweeping robot obtains the target service instruction for sweeping according to the target service name and target service parameter, and stores the target service instruction as the binary tree. The binary tree starts to execute the sweeping service, and sends the execution result of the current sub-tree to the base station, and reports the position and other conditions to the base station; then the binary tree sequence is adjusted according to the feedback from the base station to control the sweeping robot to reach the designated position for sweeping;
then, during the sweeping process, the sweeping robot has insufficient power, and the execution condition of charging (a new target service) is generated, and the priority of charging (the new target service) and sweeping (the current target service) is determined, when the priority of the charging (the new target service) is determined higher than the priority of cleaning (the current target service), the sweeping robot (the service party of the current target service) suspends sweeping, and the sweeping robot (the requesting party of the new target service) sends a charging service request to the base station (the service party of the new target service), after receiving the charging service request, the base station (the service party of the new target service) sends service information to the sweeping robot (the requesting party of the new target service). The sweeping robot selects the target service in the service information as the target service name of charging and the target service parameter, and sends the target service name and the target service parameter to the base station; the base station obtains the charging target service instruction according to the target service name and target service parameter, stores the target service instruction as the binary tree, then starts to execute the charging service according to the binary tree, and sends the execution result of the current sub-tree to the sweeping robot; and
finally, when the base station (the service party of the new target service) is finished charging, the sweeping robot (the service party of the current target service) restarts the sweeping service, reconstructs the binary tree, and recovers the sweeping service according to the binary tree.

Secondly, in the interaction scenario between the sweeping robot and the remote device, either the sweeping robot or the remote device requests service from the other party, and either the sweeping robot or the remote device is the requesting party, and the other party corresponding to the sweeping robot or the remote device is the service party, and the remote device refers to the device in the cloud that remotely interacts with the local device, and the remote device includes but not limited to mobile phones. The remote device in the embodiment of the present application requests a service from the sweeping robot, and the steps of establishing a method for communicating are:

B101, receiving and responding to, through the service party, a service request initiated by a remote device transmitted by the requesting party, and sending a service information to the requesting party, such that the requesting party selects a target service information in the service information after receiving the service information;

In step B101, when the remote device requests a service, the requesting party sends a service request to the service party, the remote device does not directly communicate with the service party; after the service party receives and responds to the service request, the service party sends service information to the requesting party, where the service information is a list including the service name and the service parameter(s); after the requesting party receives the service information, selecting the target service information corresponding to the target service from the list of the service information combining with the service request of the remote device, that is, the target service name and target service parameters, and then assembling the target service name and target service parameters into a data package and sending the data package to the service party according to the requirements of the list.

B102, receiving, through the service party, the target service information sent by the requesting party, constructing a binary tree according to the target service information, and executing the target service based on the binary tree.

In an embodiment, the target service information includes a target service name and a target service parameter, and constructing the binary tree according to the target service information includes: obtaining a target service instruction corresponding to the target service name and the target service parameter; and storing the target service instruction as a binary tree structure.

In an embodiment, executing the target service based on the binary tree includes: sending an execution result of a current sub-tree of the binary tree to the requesting party, such that the requesting party transmits the execution result to the remote device, and determining, through the remote device, a next execution sub-tree of the binary tree according to the execution result.

In step B102, after receiving the data packet including the target service name and the target service parameter sent by the requesting party, obtaining the corresponding target service instruction according to the target service name and the target service parameter, and the target service instruction is the instruction set of the target service; then storing the obtained target service instruction as a binary tree structure, the binary tree is an ordered tree with at most two sub-trees per node, and nodes can be increased or reduced according to the requirements of the service party or requesting party; and finally, executing the target service based on the binary tree through the service party, during the execution process, the execution process is started from the root node of the binary tree firstly, starting to communicate with the remote device, executing the sub-tree of the binary tree; and then sending the execution result of the current sub-tree to the remote device; then determining, through the remote device, the next execution sub-tree of the binary tree according to the execution result; then adjusting the binary tree, and determining, through the remote device, which sub-tree to enter according to the data feedback by the remote device; and when entering an empty sub-tree, the service party completes the target service process.

It can be seen that the only difference between the communication interaction between the remote device and the local device (the sweeping robot or the base station) and the communication between the local devices is that the remote device does not directly communicate with the service party, but requests the local device service through the network interface, the data that the remote device interacts with the local device needs to be processed by the requesting party first, so as to avoid the problem of privacy data leakage when the data is transferred in the cloud.

The services, service sets, and instructions in the embodiments of the present application are specifically described below:

Each service in the embodiments of the present application has a service description file, and the service description file is described in JSON format, and the format is as follows:

{
″ServiceName″: ″************″,
″ServiceType″:″*******″,
″ServiceID″: ″*********″,
″OrderBinary Tree″:
{
″OrderName″: ″***********″,
″OrderType″: ″***********″
″OrderParameter″:
{
//Parameter description in JSON format
}
″OrderResult″:
{
″YesSub-tree″: {//The instruction execution is successfully entered,
the format is the same as OrderBinary Tree, or it can be directly
defined as NULL, indicating no sub-tree},
″NoSub-tree″: {//The instruction execution fails to enter, the
format is the same as OrderBinary Tree, or it can be
directly defined as NULL, indicating no sub-tree},
}

According to the above service description file, a binary tree structure will finally be formed, which sub-tree to enter is determined according to the execution result, and the service is completed until the empty sub-tree is entered.

The service set in the embodiments of the present application is composed of a plurality of services, and the service set is described in JSON format, and the format is as follows:

{
″SetName″: ″****************″
″SetSerialNo″: ″Device Serial Number″
″SetServiceList″:
{
{″ServiceID″:″************″,
″ServiceFile″:″**********.json″},
{″ServiceID″:″************″,
″ServiceFile″:″**********.json″},
...
}
}

According to the above service description file and service set, when a new service description file is edited and downloaded to the local, the service is automatically added to the service set, and the addition and registration of service can be completed, and only registered services can be requested. The service description file can be modified and changed to complete the update of the service. The service description file can be updated through UI operations or network interface transmission.

The service in the embodiment of the present application is an instruction set described in JSON format. The instruction is defined by the system and provided to the service description file for use. The JSON format is used to describe the instruction, and the format is as follows:

The service in the embodiment of the present application is an instruction set described in JSON format. The instruction is defined by the system and provided to the service description file for use. The JSON format is used to describe the instruction, and the format is as follows:

{
″OrderName″: ″***********″,
″OrderType″: ″***********″
″OrderParameter″:
{
//Parameter description in JSON format
}
″OrderResult″:
{
″YesSub-tree″: {//The next level instruction or NULL },//If
the execution of the instruction is successful
″NoSub-tree″: {//The next level instruction or NULL },//If
the execution of the instruction fails
}
}

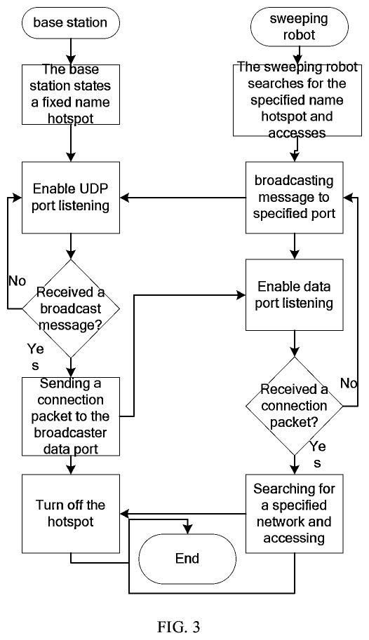

Further, the communication interaction channel between the base station and the sweeping robot in the embodiment of the present application is based on the TCP/IP protocol in the home local area network, and the communication interaction channel is implemented based on the Socket communication protocol. As shown in FIG. 3, the process of initially establishing a connection between the base station and the sweeping robot is: the base station enters a mode of searching for nearby devices, and the mode opens a hotspot with a fixed name and password; the sweeping robot searches the fixed name and password and then connects to the hotspot when the sweeping robot is turned on for the first time; after connected, the base station sends the name and password of the WiFi network are packaged and sent to the sweeping robot through the base station. The sweeping robot connects to the new WiFi network again and establishes a Socket long connection with the base station.

Due to the limited coverage of the WiFi signal of the base station, the base station power consumption and costs will be greatly increased by forcibly increasing signal coverage. Ultimately, both the base station and the robot must be connected to the home WiFi network and remain connected to the same network; the base station accessing the home WiFi network can be completed by entering the password through the touch screen, but the sweeping robot does not have an input device, so the sweeping robot can only access the base station through the hotspot of the base station preset before leaving the factory, and then obtaining the name and password of the home WiFi network from the base station, and then obtaining the information to access the home WiFi network again, and establishing a Socket long connection with the base station based on the home WiFi network.

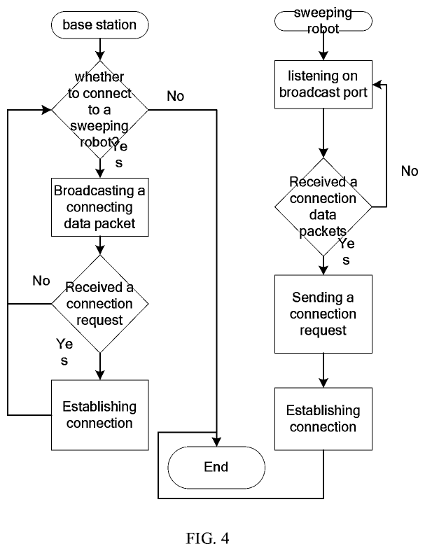

As shown in FIG. 4, the process of establishing a socket connection between the base station and the sweeping robot is that after the sweeping robot completes the access to the home WiFi network, the sweeping robot opens the port to start monitoring broadcasts, and after receiving the control instruction that the parameters of the base station broadcasted are the base station IP address and port number, establishing a Socket long connection with the base station according to the specified IP address and port number.

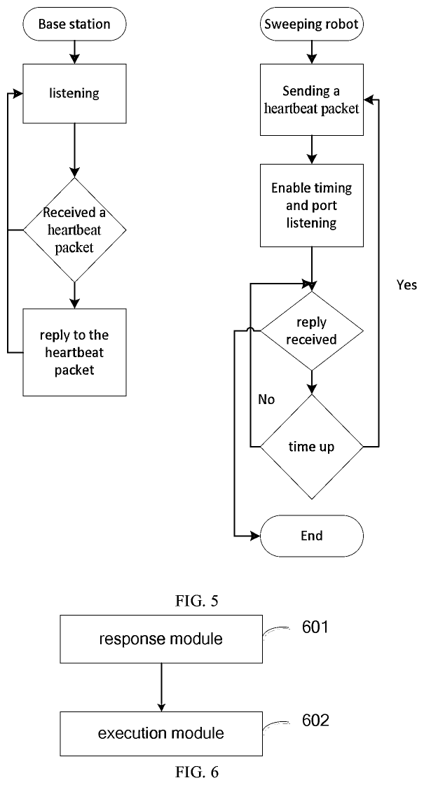

As shown in FIG. 5, the process of using heartbeat packets to maintain the socket connection between the base station and the sweeping robot is that when the data communication channel is idle, the sweeping robot sends the heartbeat packets to the base station at certain intervals; after the base station receives the heartbeat packets and inverts a heartbeat count value and send the heartbeat count value back to the sweeping robot. After the sweeping robot receives the heartbeat count value, the sweeping robot inverts the heartbeat count value again and compares the heartbeat count value with the original package to complete a heartbeat process. When the second heartbeat does not receive a response, a re-establish the Socket long connection is started.

In the private communication manner established based on the Socket connection, the interaction instructions between the base station and the sweeping robot mainly include the following three types:

According to a first type, a message received that does not need to be replied. For example, the sweeping robot reports an own status, and the sweeping robot regularly reports the own status data according to the set time interval, including power, water volume, working mode, and current location; such interaction does not require to reply by the base station; after receiving the interaction, the information is used to update the relevant display content of the base station.

According to a second type, a message received that needs to be confirmed. For example, the sweeping robot reports map update data. After the base station receives the map update data, he base station needs to send a confirmation receipt within a heartbeat cycle to indicate receipt.

According to a third type, a message of the execution result needs to reply. For example, the base station sends an instruction to start sweeping. After the sweeping robot receives the instruction, the robot decides whether to execute the sweeping instruction according to the own state (water volume, power, and other current states), and returns the result to the base station.

The operation process that requires a plurality of interactions to complete is composed of the sequence of the above three types of instructions. The binary tree is used to store the instruction sequence. The above three instructions correspond to the leaf node, the single branch node, and the two branch node.

It should be understood that the size of the sequence numbers of the steps in the above embodiments does not mean the sequence of execution, and the execution sequence of each process is determined by the function and internal logic thereof, and the size of the sequence numbers of the steps is not constituted any limitation to the implementation process of the embodiments of the present application.

As shown in FIG. 6, an embodiment of the present application further provides a system for communicating between a sweeping robot and a base station, and the system includes:
a response module 601, configured for receiving and responding to, through a service party, a service request of a requesting party to send a service information to the requesting party, such that the requesting party selects a target service information in the service information after receiving the service information; and
an execution module 602, configured for receiving, through the service party, the target service information sent by the requesting party, constructing a binary tree according to the target service information, and executing the target service based on the binary tree;
the service party is the sweeping robot or the base station, and the requesting party is the base station or the sweeping robot corresponding to the service party.

The embodiment of the present application is a modular system for communicating corresponding to the method for communicating of the above embodiment, and the principle and implementation process are the same as the method for communicating of the above embodiment, which can be referred to the description of the method for communicating of the above embodiment and are not repeated herein.

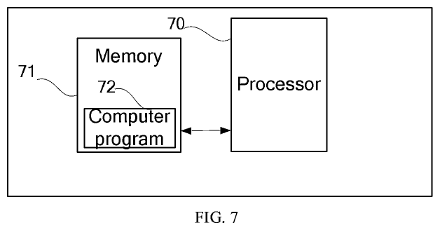

As shown in FIG. 7, a schematic diagram of an electronic device according to an embodiment of the present application is provided, including a memory 71, a processor 70, and a computer program 72 stored in the memory 71 and running on the processor 70. When the processor 70 executes the computer program 72, the steps of the method according to any one of the first aspects are implemented. Alternatively, when the processor 70 executes the computer program 72, the functions of the modules/units in the foregoing device embodiments are implemented.

An embodiment of the present application further provides a computer-readable storage medium, where the computer-readable storage medium stores a computer program, and when the computer program is executed by a processor, implements the steps of any one of the methods described in the first aspect.

Those skilled in the art can clearly understand that, for the convenience and simplicity of description, only the division of the above-mentioned functional units and modules is used as an example for illustration. In practical applications, the above-mentioned functions can be allocated to complete by different functional units and modules according to needs, that is, dividing the internal structure of the device into different functional units or modules to complete all or part of the functions described above. Each functional unit and module in the embodiment can be integrated in one processing unit, or each unit can exist physically alone, or two or more units can be integrated into one unit, and the above-mentioned integrated units can adopt hardware, and can also be realized in the form of software functional units. In addition, the specific names of the functional units and modules are only for the convenience of distinguishing from each other, and are not used to limit the protection scope of the present application. For the specific working processes of the units and modules in the above-mentioned system, reference may be made to the corresponding processes in the foregoing method embodiments, which will not be repeated here.

In the foregoing embodiments, the description of each embodiment has its own emphasis. For parts that are not described or described in detail in a certain embodiment, reference may be made to the relevant descriptions of other embodiments.

Those skilled in the art may aware that, the elements and algorithm steps of each of the examples described in connection with the embodiments disclosed herein can be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

In the embodiments provided in the present application, it should be understood that, in the embodiments of the present application, the disclosed device/terminal device and method could be implemented in other ways. For example, the device described above are merely illustrative; for example, the division of the units is only a logical function division, and other division could be used in the actual implementation, for example, multiple units or components could be combined or integrated into another system, or some features can be ignored, or not performed. In another aspect, the coupling or direct coupling or communicating connection shown or discussed could be an indirect, or a communicating connection through some interfaces, devices or units, which could be electrical, mechanical, or otherwise.

The units described as separate components could or could not be physically separate, the components shown as units could or could not be physical units, which can be located in one place, or can be distributed to multiple network elements. Parts or all of the elements could be selected according to the actual needs to achieve the object of the present embodiment.

In addition, the various functional units in each of the embodiments of the present application can be integrated into a single processing unit, or exist individually and physically, or two or more than two units are integrated into a single unit. The aforesaid integrated unit can either be achieved by hardware, or be achieved in the form of software functional units.

If the integrated unit is achieved in the form of software functional units, and is sold or used as an independent product, it can be stored in a computer readable storage medium.

Based on this understanding, a whole or part of flow process of implementing the method in the aforesaid embodiments of the present application can also be accomplished by using computer program to instruct relevant hardware. When the computer program is executed by the processor, the steps in the various method embodiments described above can be implemented. Wherein, the computer program comprises computer program codes, which can be in the form of source code, object code, executable documents or some intermediate form, etc. The computer readable medium can include: any entity or device that can carry the computer program codes, recording medium, USB flash disk, mobile hard disk, hard disk, optical disk, computer storage device, ROM (Read-Only Memory), RAM (Random Access Memory).

As stated above, the aforesaid embodiments are only intended to explain but not to limit the technical solutions of the present application. Although the present application has been explained in detail with reference to the above-described embodiments, it should be understood for the ordinary skilled one in the art that, the technical solutions described in each of the above-described embodiments can still be amended, or some technical features in the technical solutions can be replaced equivalently; these amendments or equivalent replacements, which won't make the essence of corresponding technical solution to be broken away from the spirit and the scope of the technical solution in various embodiments of the present application, should all be included in the protection scope of the present application.

1. A method for communicating between a sweeping robot and a base station, comprising:
receiving and responding to, by a service party, a service request sent by a requesting party to send a service information to the requesting party, and selecting a target service information in the service information after the requesting party has received the service information;
receiving, by the service party, the target service information sent by the requesting party, constructing a binary tree according to the target service information, and executing the target service based on the binary tree;
determining whether a priority of a new target service is higher than a priority of a target service currently executed when an execution condition of the new target service is generated;
suspending the target service currently executed through the service party, and preferentially executing the new target service when the priority of the new target service is higher than the priority of the target service currently executed; and
reconstructing a binary tree according to the target service information, and recovering to execute the target service based on the binary tree reconstructed after the new target service has been preferentially executed;
wherein the service party is one of a sweeping robot and a base station, and the requesting party is the other one of the base station and the sweeping robot corresponding to the service party;
wherein the target service information comprises a target service name and a target service parameter, and the constructing the binary tree according to the target service information comprises:
obtaining a target service instruction corresponding to the target service name and the target service parameter; and
storing the target service instruction as a binary tree structure;
wherein, the service information is a service information including all the services of the sweeping robot and the base station, and the target service instruction is configured for a mutual control and information interaction between the sweeping robot and the base station.

2. (canceled)

3. The method for communicating between a sweeping robot and a base station according to claim 1, wherein executing the target service based on the binary tree comprises:
sending an execution result of a current sub-tree of the binary tree to the requesting party, and determining a next execution sub-tree of the binary tree according to the execution result after the requesting party has received the execution result.

4. The method for communicating between a sweeping robot and a base station according to claim 1, wherein receiving and responding to, through the service party, the service request of the requesting party comprises:
receiving and responding to, through the service party, a service request initiated by a remote device transmitted by the requesting party; and
executing the target service based on the binary tree comprises:
sending an execution result of a current sub-tree of the binary tree to the requesting party, transmitting the execution result to the remote device by the requesting party, and determining, through the remote device, a next execution sub-tree of the binary tree according to the execution result.

5. The method for communicating between a sweeping robot and a base station according to claim 1, wherein receiving and responding to, through the service party, the service request of the requesting party comprises:
receiving, through the service party, one or more service requests sent by one or more requesting parties, and responding to a service request with a highest priority.

6-7. (canceled)

8. An electronic device, comprising a memory, a processor, and a computer program stored in the memory and running on the processor, wherein when the computer program is executed by the processor, steps of a method are implemented, and the processor is further configured for:
receiving and responding to, by a service party, a service request sent by a requesting party to send a service information to the requesting party, and selecting a target service information in the service information after the requesting party has received the service information;
receiving, by the service party, the target service information sent by the requesting party, constructing a binary tree according to the target service information, and executing the target service based on the binary tree;
determining whether a priority of a new target service is higher than a priority of a target service currently executed when an execution condition of the new target service is generated;
suspending the target service currently executed through the service party, and preferentially executing the new target service when the priority of the new target service is higher than the priority of the target service currently executed; and
reconstructing a binary tree according to the target service information, and recovering to execute the target service based on the binary tree reconstructed after the new target service has been preferentially executed;
wherein the service party is one of a sweeping robot and a base station, and the requesting party is the other one of the base station and the sweeping robot corresponding to the service party;
wherein the target service information comprises a target service name and a target service parameter, and the constructing the binary tree according to the target service information comprises:
obtaining a target service instruction corresponding to the target service name and the target service parameter; and
storing the target service instruction as a binary tree structure;
wherein, the service information is a service information including all the services of the sweeping robot and the base station, and the target service instruction is configured for the mutual control and information interaction between the sweeping robot and the base station.

9. (canceled)

10. The electronic device according to claim 8, wherein executing the target service based on the binary tree comprises:
sending an execution result of a current sub-tree of the binary tree to the requesting party, and determining a next execution sub-tree of the binary tree according to the execution result after the requesting party has received the execution result.

11. The electronic device according to claim 8, wherein receiving and responding to, through the service party, the service request of the requesting party comprises:
receiving and responding to, through the service party, a service request initiated by a remote device transmitted by the requesting party; and
executing the target service based on the binary tree comprises:
sending an execution result of a current sub-tree of the binary tree to the requesting party, transmitting the execution result to the remote device by the requesting party, and determining, through the remote device, a next execution sub-tree of the binary tree according to the execution result.

12. The electronic device according to claim 8, wherein receiving and responding to, through the service party, the service request of the requesting party comprises:
receiving, through the service party, one or more service requests sent by one or more requesting parties, and responding to a service request with a highest priority.

13-14. (canceled)

15. A non-transitory computer-readable storage medium storing a computer program, wherein when the computer program is executed by a processor, steps of a method are implemented, and
the processor is further configured for:
receiving and responding to, by a service party, a service request sent by a requesting party to send a service information to the requesting party, and selecting a target service information in the service information after the requesting party has received the service information; and
receiving, by the service party, the target service information sent by the requesting party, constructing a binary tree according to the target service information, and executing the target service based on the binary tree;
determining whether a priority of a new target service is higher than a priority of a target service currently executed when an execution condition of the new target service is generated;
suspending the target service currently executed through the service party, and preferentially executing the new target service when the priority of the new target service is higher than the priority of the target service currently executed; and
reconstructing a binary tree according to the target service information, and recovering to execute the target service based on the binary tree reconstructed after the new target service has been preferentially executed;
wherein the service party is one of a sweeping robot and a base station, and the requesting party is the other one of the base station and the sweeping robot corresponding to the service party;
wherein the target service information comprises a target service name and a target service parameter, and the constructing the binary tree according to the target service information comprises:
obtaining a target service instruction corresponding to the target service name and the target service parameter; and
storing the target service instruction as a binary tree structure;
wherein, the service information is a service information including all the services of the sweeping robot and the base station, and the target service instruction is configured for the mutual control and information interaction between the sweeping robot and the base station.

16. (canceled)

17. The non-transitory computer-readable storage medium according to claim 15, wherein executing the target service based on the binary tree comprises:
sending an execution result of a current sub-tree of the binary tree to the requesting party, and determining a next execution sub-tree of the binary tree according to the execution result after the requesting party has received the execution result.

18. The non-transitory computer-readable storage medium according to claim 15, wherein receiving and responding to, through the service party, the service request of the requesting party comprises:
receiving and responding to, through the service party, a service request initiated by a remote device transmitted by the requesting party; and
executing the target service based on the binary tree comprises:
sending an execution result of a current sub-tree of the binary tree to the requesting party, transmitting the execution result to the remote device by the requesting party, and determining, through the remote device, a next execution sub-tree of the binary tree according to the execution result.

19. The non-transitory computer-readable storage medium according to claim 15, wherein receiving and responding to, through the service party, the service request of the requesting party comprises:
receiving, through the service party, one or more service requests sent by one or more requesting parties, and responding to a service request with a highest priority.

20. (canceled)
